(19) United States
(12) Patent Application Publication
(10) Pub. No.: US 2009/0098815 A1
(43) Pub. Date: Apr. 16, 2009

(54) USER SPECIFIC CLIMATE CONTROL SYSTEM

(75) Inventor: James Hotary, Holland, MI (US)

Correspondence Address: GIBSON & DERNIER L.L.P., 900 ROUTE 9 NORTH, SUITE 504, WOODBRIDGE, NJ, 07095, US

(73) Assignee: FAURECIA INTERIOR SYSTEMS U.S.A., INC., Auburn Hills, MI (US)

(21) Appl. No.: 12/249,278

(22) Filed: Oct. 10, 2008

Related U.S. Application Data
(60) Provisional application No. 60/978,876, filed on Oct. 10, 2007.

(51) Int. Cl. B60H 1/34; F24F 7/007; B60H 1/00; G05D 7/00

(52) U.S. Cl. 454/75; 454/358; 454/152; 700/282

(57) ABSTRACT

A climate control system is provided with a control vent unit that a driver may adjust for a desired direction of airflow. After the driver does so, a control system automatically and/or simultaneously adjusts the position of the remaining vents so as to direct respective air flow to substantially the same location in the vehicle. Preferably, a similar control vent is provided on the passenger side of the vehicle. Should a passenger adjust the passenger control vent unit, the control system will automatically and/or simultaneously adjust the remaining vents on the passenger side to direct the respective air flow to the selected position in the passenger side of the vehicle.

### CROSS-REFERENCE TO RELATED APPLICATIONS

This application claims the benefit of U.S. Provisional Patent Application No. 60/978,876, filed Oct. 10, 2007, the entirety of which is incorporated herein by reference.

### FIELD OF THE INVENTION

The present invention is directed to climate control systems that employ control units to adjust and position one or more airflow direction devices for one or more users, for use in a vehicle, or the like.

### BACKGROUND OF THE INVENTION

The present invention relates generally to climate control systems of the type used in automotive vehicles and, more particularly, concerns an improvement to climate control systems which allows them to be adjusted to the preference of the driver and the passengers simultaneously and/or automatically.

Climate control systems are now available in virtually all new vehicles. Some such systems allow individualized control by the driver and the passenger, even when they are both sitting side-by-side, for example, in the front seat of the vehicle. Typically, the driver can make adjustments on a control console, for example on the vehicle dashboard, and the adjustments apply to the entire vehicle. In some vehicles, if a passenger also makes adjustments, his vent units are decoupled from those provided for the driver, and he may make separate adjustment for himself. In some instances, the vehicle may include a seat sensor, or the like, which senses the presence of a passenger and maintains the passengers adjustments as long as he is present. What has been absent in climate control systems until now is the ability to control the direction of air flow in a selective manner. Typically, the driver and/or the passenger must adjust each vent unit of the climate control systems separately to achieve a desired air flow pattern. Moreover, when only a driver is present, he must adjust all of the vent unit's separately. Since some of them are normally out of his reach, he is not able to do so in a safe manner while driving, without taking his attention from the road and risking an accident. Because the driver must make complex body and/or arm movements when manually adjusting and positioning each of the air flow vents out of his reach, vehicles employing such vent units lack desired ergonomics and ease of operation for controlling climate and/or air flow in the vehicle while contributing to unsafe driving conditions.

It would therefore be desirable to provide a climate control system in which air flow maybe adjusted conveniently and accurately, without distracting the driver's attention from the road. It would also be desirable if the same system could provide control by a passenger when present, so that he can adjust his vents appropriately, without affecting the adjustment that the driver has made to the drivers vents.

### SUMMARY OF THE INVENTION

In accordance with the present invention, a climate control system is provided with a master vent control unit that the driver may adjust for the desire direction of airflow. After he does so, a control system adjusts the position of the remaining vents so as to direct air flow to substantially the same location in the vehicle. Preferably, a similar control vent is provided on the passenger side of the vehicle. Should a passenger adjust that vent, the control system will adjust the remaining vents on his side to direct the air flow to the same position in the passenger vehicle that he has selected. Preferably, the seat sensor, or the like, is provided which causes the passenger vents to be readjusted to the driver's selection when he is no longer present. Alternatively, the passenger control vent unit may simply have a sensor that overrides the driver's adjustment for the passenger vents when operated, and that adjustment is retained until the vehicle is turned off and/or re-started.

In accordance with one or more embodiments of the present invention, a climate control system includes: at least one air flow direction device for directing at least one air flow to a space; at least another air flow direction device for directing at least another air flow; and an air flow direction device control unit which adjusts the at least another air flow direction device to direct the at least another air flow to the space. The system may further include at least one motor connected to the at least another air flow direction device such that the air flow direction device control unit produces a drive signal for the at least one motor to adjust the respective at least another air flow direction device.

The climate control system may further include at least another air flow direction device control unit; and at least one sensor for detecting the presence and/or absence of a user in a second space. When the at least one sensor detects the presence of a user in the second space, the at least one sensor signals the at least another air flow direction device control unit to override the air flow direction device control unit and to adjust the at least another air flow direction device to direct the at least another air flow to the second space. On the contrary, when the sensor detects the absence of the user in the second space, the at least one sensor signals the another air flow direction device control unit to not override the air flow direction device control unit when the sensor detects the absence of the user in the second space.

In one or more embodiments, the space and the second space may be a point, a line, a surface area, a volume, or the like.

The at least one sensor may be disposed in and/or on the at least one air flow direction device, the air flow direction device control unit, the at least another air flow direction device, and the at least another air flow direction device control unit, or the like.

The climate control system may further include a switch. When the switch is in a first position, the air flow direction device control unit overrides the at least another air flow direction device control unit, and when the switch is in a second position, the at least another air flow direction device control unit overrides the air flow direction device control unit. The switch may be in the first position if no user is in the second space, and the switch may be in the second position when a user is in the second space.

Alternatively, the switch may be in the first position by default, and the switch moves into the second position when a user applies a force to the at least another air flow direction device control unit. The switch may reset to the default first position when the system is turned off and/or restarts.

In accordance with an alternative aspect, a vehicle climate control system includes: a driver control vent unit for directing an air flow to a space; and at least another vent unit, such that the driver control vent unit adjusts the at least another vent unit to direct at least another air flow to the space. The vehicle climate control system may further include at least one drive motor connected to the at least another vent unit, such that the at least one control unit produces a drive signal for the at least one drive motor to adjust the respective at least another vent unit towards the space.

The vehicle climate control system may further include: a driver unit controller; and at least one driver adjustment sensor for detecting a position of adjustment of the driver control vent unit, such that a signal of the at least one driver adjustment sensor sends the adjustment position to the driver unit controller for producing the drive signal to the at least one drive motor.

The vehicle climate control system may further include a passenger control vent unit. Similarly to the aforementioned climate control system, the vehicle climate control system may employ sensors and a switch for detecting the presence and/or absence of a passenger in a second space, and responding accordingly.

In one or more embodiments, at least one of the at least another vent unit is in and/or on a passenger side of the vehicle. The passenger side of the vehicle may be, but not limited to, to the right of the driver, to the right of a longitudinal axis substantially aligned with the middle of a dashboard, to the right of a console, to a side including a seat for the passenger, or the like.

The vehicle climate control system may include: a passenger unit controller; and at least one passenger adjustment sensor for detecting a position of adjustment of the passenger control vent unit, such that a signal of the at least one passenger adjustment sensor sends the adjustment position to the passenger unit controller for producing the drive signal to the at least one drive motor.

The at least one driver adjustment sensor, the at least one passenger sensor, and the at least one passenger adjustment sensor may be disposed in and/or on a dashboard, the driver control vent unit, a control console, a center console, the driver unit controller, the passenger control vent unit, the passenger unit controller, the passenger seat, the passenger side of the vehicle, or the like.

In accordance with yet a further aspect of the present invention, a method for controlling air flow includes: adjusting at least one control vent unit for directing at least one air flow to a space; determining an angular orientation of the at least one control vent unit based upon a reference line spaced away from the at least one control vent unit and running through the space, wherein an angle of the determined angular orientation is the angle between the at least one air flow from the at least one control vent unit to the space and a perpendicular line from the at least one control vent unit to the reference line; determining a location of the space with respect to at least another vent unit for directing at least another air flow to the space based upon the reference line, a known relative position of the at least one control vent unit to the at least another vent unit, and the angular orientation of the at least one control vent unit; determining an angular adjustment of the at least another vent unit, wherein an angle of the determined angular adjustment is the angle between a perpendicular line from the at least another vent unit to the reference line and a line from the at least another vent unit to the determined location of the space; and adjusting the at least another vent unit to direct the at least another air flow to the space. The adjustment of a plurality of the at least another vent may be simultaneous and/or automatic, and the reference line may be a reference position of a front seat, the actual sensed position of the front seat, or the like.

In one or more embodiments, the method may further include determining a drive signal that must be applied to at least one drive motor for adjusting the at least another vent unit towards the space.

The types of vehicles in which the present invention may be employed are numerous and include: automobiles, planes, trains, trucks, buses, boats, helicopters, submersible vehicles, spacecraft, etc.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown, but rather only by the claims. The drawings may not be to scale, and the aspects of the drawings may not be to scale relative to each other. To assist those of ordinary skill in the relevant art in making and using the subject matter hereof, reference is made to the appended drawings and figures, wherein:

FIG. 1 is an interior view of an automobile showing a driver from the rear and a dashboard embodying the present inventions, the driver being shown adjusting a driver's control vent unit.

FIG. 2 is an interior view of the same automobile as FIG. 1, after a passenger has entered and occupied the passenger seat.

FIG. 3 is a schematic block diagram of a preferred control system embodying the present invention.

FIG. 4 is a drawing illustrating a preferred method for determining the angular orientation the of a slave vent unit based upon the adjustment of a master unit.

### DETAILED DESCRIPTION OF THE PRESENT INVENTION

Vehicle climate control systems are disclosed herein for controlling airflow direction with the use of control units for adjusting and positioning one or more airflow direction devices for one or more users, such as a driver, a passenger, etc. The systems may be employed in automobiles, planes, trains, trucks, buses, boats, helicopters, submersible vehicles, spacecraft, or the like. In particular, the present invention relates to vehicle climate control systems that provide desired ergonomics and ease of operation (e.g., due to less complex arm movement without having to manually adjust and position each airflow direction device separately) of at least one control unit that adjusts and positions airflow direction devices to provide desired airflow according to the desired adjustments of the one or more users.

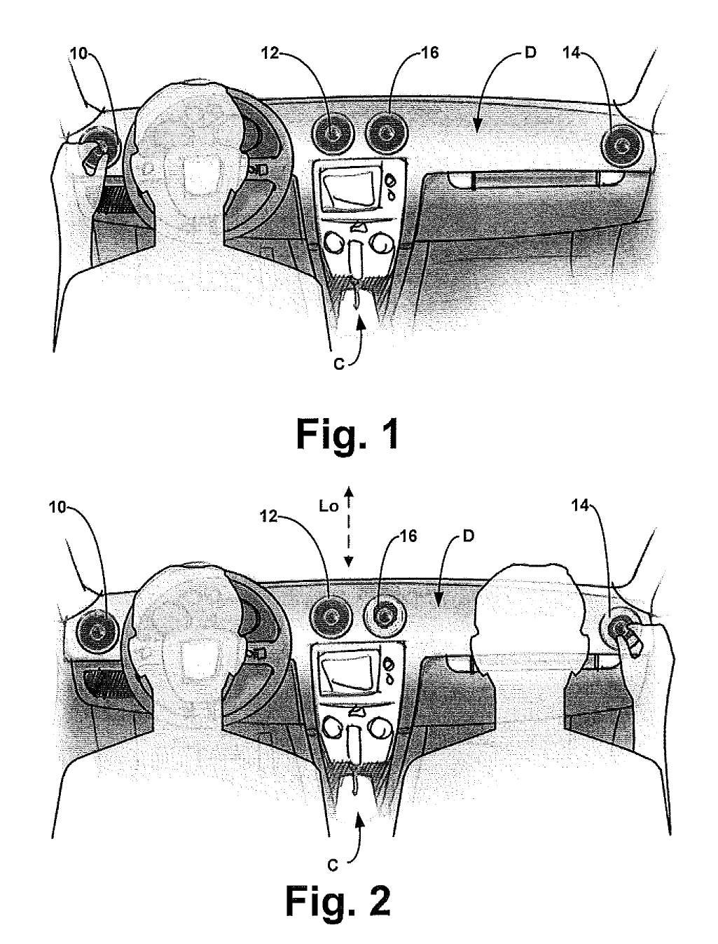

Turning now to the details of the drawings, FIG. 1 is an interior view of an automobile showing a driver from the rear and a dashboard D in accordance with at least one embodiment of the present invention. The driver is shown adjusting a driver control vent unit 10. The vehicle further includes a driver vent unit 12, a passenger control unit 14, and a passenger vent unit 16. The vent units 10, 12, 14, 16 may be formed from metal, plastic, polymer, rubber, or the like, and the vent units 10, 12, 14, 16 may be molded and/or shaped in any manner known to those skilled in the art, such as but not limited to, spheres, squares, circles, triangles, or the like. Preferably, vent units 12, 14, and 16 are slaved to control unit 10. That is, when the driver adjusts control unit 10 to deliver airflow to a particular location in the vehicle, vent units 12, 14 and 16 are adjusted to deliver airflow to the same location, such as a point, a line, a surface area, a volume, or the like. For example, a line could be defined as representing the average position of the front seat (or a front seat position sensor could be provided), and vents 12, 14, and 16 could be controlled to direct air flow to the same location on the front seat as vent unit 10.

FIG. 2 is an interior view of the same automobile as FIG. 1, after a passenger has entered and occupied the passenger seat. The passenger is operating the passenger control vent unit 14 to adjust the airflow as he desires. Through a seat sensor, or as a result of a sensor inside vent unit 14, the presence of the passenger is detected, and the adjustment on control vent unit 14 overrides the adjustment on vent unit 10 so that the airflow from unit 16 is directed to the same location as that selected by the passenger via control unit 14.

In accordance with at least one embodiment as shown in FIG. 2, when a passenger is present in the vehicle, the passenger control vent unit 14 may be adjusted to control, but is not limited to, any number of vent units on the passenger's side of the vehicle as indicated to the right of longitudinal axis, Lo, such as vent unit 16. In at least one embodiment, longitudinal axis, Lo, is substantially aligned with the middle of a dashboard. The driver control vent unit 10 may be adjusted to control, but is not limited to, any number of vent units on the driver's side of the vehicle as indicated to the left of the longitudinal axis, Lo, such as vent unit 12. The passenger's side of the vehicle may also be indicated as being substantially to the right of center console, C, while the driver's side of the vehicle is substantially to the left of the center console, C. In at least another embodiment, the partitioning of the driver's side and passenger's side may be indicated via other components of the vehicle, such as, but not limited to, a driver seat, a passenger seat, a rear view mirror, a portion of the dashboard, or the like.

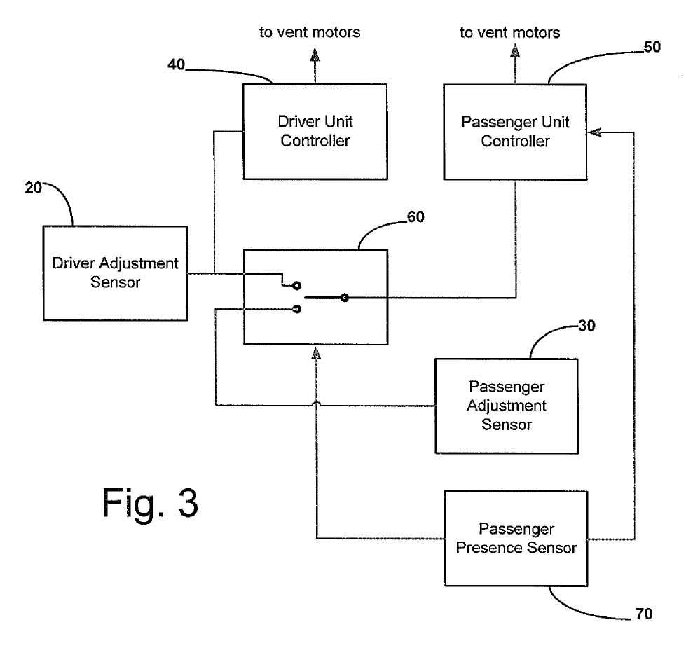

FIG. 3 is a schematic block diagram of a preferred control system in accordance with at least one embodiment of the present invention. A driver adjustment sensor 20 is provided in a location in the vehicle, such as, but not limited to, behind the dashboard D, on or in a console, on or in a seat, or the like to sense the position of adjustment of control vent unit 10. Appropriate position sensors, such as, but not limited to, Hall effect sensors, or the like, are well know and widely available.

A similar sensor 30 is provided in a location in the vehicle, such as, but not limited to, behind dashboard D, on or in a console, on or in a seat, or the like to sense the position of control vent unit 14. A driver unit controller 40 is provided to determine the appropriate position of vent unit 12 and any other vent units available on the driver's side, and a similar passenger unit controller 50 is provided to determine the appropriate adjustment for vent unit 14 and/or 16. Units 40 and 50 produce drive signals for motors that are to adjust respective vent units. Various types of motors are useful for this purpose, but it is contemplated for at least one embodiment that vibrator motors designed for paging units, cell phones, or the like would be utilized, with the vibrating element removed. Driver adjustment sensor 20 is connected directly to driver unit controller 40 and to a control electrical switch 60. A signal from passenger adjustment sensor 30 is also provided as an input to switch 60, and the operator passenger sensor 70 output is provided as a control signal to switch 60. An output from switch 60 is provided as an input for the passenger unit controller 50 and the output of sensor 70 is provided as a second control input thereto.

In operation, in the absence of the passenger, switch 60 is in its upward, or a first, position and the passenger sensor provides an indication to passenger unit controller 50 that no passenger is present. Any adjustment made by the driver is therefore applied to driver unit controller 40 and passenger unit controller 50. The controllers 40, 50 therefore process the signal provided from sensor 20 and generate appropriate drive signals for vent motors to adjust them as selected by the driver. The controllers 40, 50 may employ any processor useful for this purpose, and such processors are known to those skilled in the art. Should a passenger be present, passenger sensor 70 will control switch 60 so as to move it to its downward, or a second, position and will provide an indication to passenger unit controller 50 that a passenger is present. Passenger unit controller 50 will then receive whatever signal is provided by passenger adjustment sensor 30 and will produce appropriate driving signals for the passenger's side vent motors to adjust them to the position selected by the passenger.

It is contemplated that passenger sensor 70 can be a seat sensor, a dashboard sensor, a control console sensor, a center console sensor, or the like. In this event, when the passenger leaves the vehicle, an appropriate indication is provided to passenger unit control 50 and switch 60, and vent units 14 and 16 may then be readjusted based upon the driver adjustment sensor 20. Alternatively, passenger sensor 70 may simply be a sensor on control vent unit 14 which senses when the passenger applies a force to the unit. Switch 60 will then be adjusted appropriately based upon an appropriate indication provided from sensor 70 to passenger unit controller 50, and vent unit 16 (and any other passenger vent units) will be adjusted appropriately. In this case, the passenger adjustment would be retained until the vehicle is turned off and/or restarted.

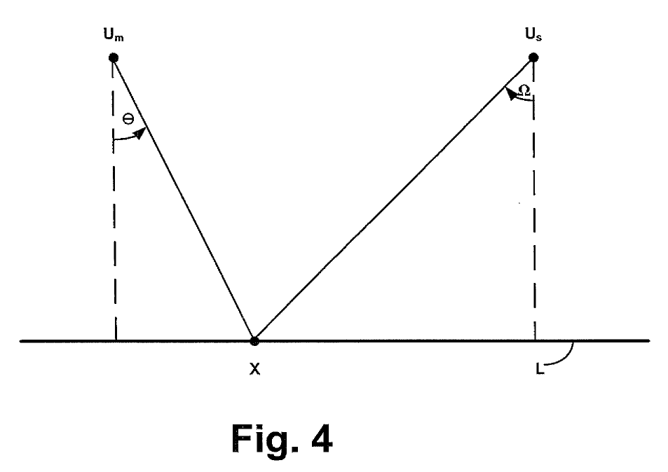

FIG. 4 is a drawing illustrating a preferred method for determining the angular orientation of a slave vent unit (12, 14, 16) based upon the adjustment of a master unit (10, 14). A reference line, L, is defined as either a reference position of the front seat, or it may be determined by sensing the actual position of the seat. Based on the defined position of line, L, the known relative position of the master, Uₘ, and the angular adjustment, θ, of that unit relative to a perpendicular to line, L, it is possible to determine, from geometry, the location of a point, X, to which the slave unit, Uₛ, is directed. With point, X, defined, and the position of the slave unit known, it is possible to determine the necessary angular adjustment, Ω, of the slave unit to have it also directed at point, X. This, in turn, determines the drive signal that must be applied to the drive motor for the slave unit to position it appropriately. Thus, through geometry, the angular orientation of all slave units is easily determined based upon the sensed orientation of a master unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A climate control system, comprising:
at least one air flow direction device for directing at least one air flow to a space;
at least another air flow direction device for directing at least another air flow; and
an air flow direction device control unit which adjusts the at least another air flow direction device to direct the at least another air flow to the space.

2. The climate control system of claim 1, further comprising at least one motor connected to the at least another air flow direction device, wherein the air flow direction device control unit produces a drive signal for the at least one motor to adjust the respective at least another air flow direction device.

3. The climate control system of claim 1, further comprising:
at least another air flow direction device control unit; and
at least one sensor for detecting the presence and/or absence of a user in a second space, wherein
the at least one sensor signals the at least another air flow direction device control unit to override the air flow direction device control unit and to adjust the at least another air flow direction device to direct the at least another air flow to the second space when the at least one sensor detects the presence of a user in the second space; and
the at least one sensor signals the another air flow direction device control unit to not override the air flow direction device control unit when the at least one sensor detects the absence of the user in the second space.

4. The climate control system of claim 3, wherein the space and the second space are at least one of: a point, a line, a surface area, and a volume.

5. The climate control system of claim 3, wherein the at least one sensor is disposed in and/or on at least one of: the at least one air flow direction device, the air flow direction device control unit, the at least another air flow direction device, and the at least another air flow direction device control unit.

6. The climate control system of claim 3, further comprising a switch, wherein
the air flow direction device control unit overrides the at least another air flow direction device control unit when the switch is in a first position, and
the at least another air flow direction device control unit overrides the air flow direction device control unit when the switch is in a second position.

7. The climate control system of claim 6, wherein the switch is in the first position when the user is not in the second space, and the switch is in the second position when the user is in the second space.

8. The climate control system of claim 1, further comprising:
at least one sensor, wherein
the at least one sensor signals the at least another air flow direction device control unit to override the air flow direction device control unit and to adjust the at least another air flow direction device to direct the at least another air flow to a second space.

9. The climate control system of claim 8, wherein the at least one sensor is disposed in and/or on at least one of: the at least one air flow direction device, the air flow direction device control unit, the at least another air flow direction device, and the at least another air flow direction device control unit.

10. The climate control system of claim 8, further comprising a switch, wherein
the air flow direction device control unit overrides the at least another air flow direction device control unit when the switch is in a first position, and
the at least another air flow direction device control unit overrides the air flow direction device control unit when the switch is in a second position.

11. The climate control system of claim 10, wherein the switch is in the first position by default, and the switch moves into the second position when a user applies a force to the at least another air flow direction device control unit.

12. The climate control system of claim 11, wherein the switch resets to the default first position when the system is turned off and/or restarted.

13. A vehicle climate control system, comprising:
a driver control vent unit for directing an air flow to a space; and
at least another vent unit,
wherein the driver control vent unit adjusts the at least another vent unit to direct at least another air flow to the space.

14. The vehicle climate control system of claim 13, further comprising:
at least one drive motor connected to the at least another vent unit, wherein the at least one control unit produces a drive signal for the at least one drive motor to adjust the respective at least another vent unit towards the space.

15. The vehicle climate control system of claim 14, further comprising:
a driver unit controller; and
at least one driver adjustment sensor for detecting a position of adjustment of the driver control vent unit, wherein a signal of the at least one driver adjustment sensor sends the adjustment position to the driver unit controller for producing the drive signal to the at least one drive motor.

16. The climate control system of claim 15, wherein the at least one driver adjustment sensor is disposed in and/or on at least one of: a dashboard, the driver control vent unit, a control console, a center console, and the driver unit controller.

17. The vehicle climate control system of claim 14, further comprising:
a passenger control vent unit; and
at least one passenger sensor for detecting the presence and/or absence of a passenger in a second space, wherein
the at least one passenger sensor signals the passenger control vent unit to override the driver control vent unit and to adjust at least one of the at least another vent unit to direct at least one of the at least another air flow to the second space when the at least one passenger sensor detects the presence of the passenger in the second space; and
the at least one passenger sensor signals the passenger control unit to not override the driver control vent unit when the at least one passenger sensor detects the absence of the passenger in the second space.

18. The vehicle climate control system of claim 17, wherein the at least one of the at least another vent unit is in and/or on a passenger side of the vehicle.

19. The vehicle climate control system of claim 17, wherein the passenger side of the vehicle is at least one of: to the right of the driver, to the right of a longitudinal axis substantially aligned with the middle of a dashboard, to the right of a console, and to a side including a seat for the passenger.

20. The vehicle climate control system of claim 17, further comprising:
a passenger unit controller; and
at least one passenger adjustment sensor for detecting a position of adjustment of the passenger control vent unit, wherein a signal of the at least one passenger adjustment sensor sends the adjustment position to the passenger unit controller for producing the drive signal to the at least one drive motor.

21. The vehicle climate control system of claim 18, wherein the at least one passenger sensor and the at least one passenger adjustment sensor are disposed in and/or on at least one of: a dashboard, a center console, the passenger control vent unit, the passenger unit controller, the passenger seat, the passenger side of the vehicle, and a control console.

22. A method for controlling air flow, comprising:
adjusting at least one control vent unit for directing at least one air flow to a space;
determining an angular orientation of the at least one control vent unit based upon a reference line spaced away from the at least one control vent unit and running through the space, wherein an angle of the determined angular orientation is the angle between the at least one air flow from the at least one control vent unit to the space and a perpendicular line from the at least one control vent unit to the reference line;
determining a location of the space with respect to at least another vent unit for directing at least another air flow to the space based upon the reference line, a known relative position of the at least one control vent unit to the at least another vent unit, and the angular orientation of the at least one control vent unit;
determining an angular adjustment of the at least another vent unit, wherein an angle of the determined angular adjustment is the angle between a perpendicular line from the at least another vent unit to the reference line and a line from the at least another vent unit to the determined location of the space; and
adjusting the at least another vent unit to direct the at least another air flow to the space.

23. The method for controlling air flow of claim 22, further comprising: determining a drive signal that must be applied to at least one drive motor for adjusting the at least another vent unit towards the space.

24. The method for controlling air flow of claim 22, wherein the adjustment of a plurality of the at least another vent is simultaneous and/or automatic.

25. The method for controlling air flow of claim 22, wherein the reference line is at least one of: a reference position of a front seat, and the actual sensed position of the front seat.
